(19) United States
(12) Patent Application Publication
(10) Pub. No.: US 2003/0106991 A1
(43) Pub. Date: Jun. 12, 2003

(54) Off-axis light-detector assembly

(76) Inventors: Moshe Klotz, London (GB); Hagai Sigalov, London (GB)

Correspondence Address: BIRCH STEWART KOLASCH & BIRCH, PO BOX 747, FALLS CHURCH, VA, 22040-0747, US

(21) Appl. No.: 10/149,070

(22) PCT Filed: Dec. 6, 2000
(86) PCT No.: PCT/GB00/04664

(30) Foreign Application Priority Data
Dec. 7, 1999 (GB) 9928966.2
Jan. 6, 2000 (GB) 0000175.0

(51) Int. Cl. G06M 7/00

(52) U.S. Cl. 250/221

(57) ABSTRACT

A light-detector assembly is provided for use with light-actuated, selectively operable, electronic triggering equipment for triggering a wide variety of different kinds of events, particularly performance, entertainment, advertising or information events. Said assembly comprises light-detecting means (19; 53; 80); means for locating said light-detecting means off-axis in relation to a collimated source of visible light (L; 40), light deflecting means (18; 52; 78); and positioning means (14: 46; 74) for positioning said light-detecting means on the optical axis of said collimated source; wherein said deflecting means are adapted to deflect towards said light detecting means, light, such as retro-reflected light, that is directed towards the source. Said deflecting means may comprise a mirror (19, 53, 76) adapted to reflect said light to the light detector, and in some embodiments the deflecting means (78) may comprise a plurality of mirrors (76) and a corresponding plurality of light-detectors (80) may be provided that are spaced around the beam, wherein each of the light-detectors is collimated with a respective one of the mirrors.

The present invention relates to a light-detector assembly for use with light-actuated, selectively operable, electronic triggering equipment of the kind in which light is directed towards a light source to impinge on a detector, whereby an output trigger signal is generated when the light beam impinges on, or alternatively is blocked from, the detector. The light that is directed to the source may be light from the source that is retro-reflected back towards said source.

Light-actuated triggering equipment of the kind referred to above can be used for triggering a wide variety of different kinds of events, particularly performance, entertainment, advertising or information events. For instance, said equipment maybe used to drive a sound engine to produce sound, particularly music, or, more generally, to operate audio or visual devices such, for example, as computer audio cards, sound modules, samplers, digital display devices and stage effect devices (e.g. smoke machines). Typically, such equipment comprises at least one source of visible light and means for producing at least one beam of collimated light from said source. A light-detector is associated with the or each beam and comprises a light-sensitive element which generates an output signal when light from the beam impinges on it. Said light-detector is collimated with the beam and is positioned in the vicinity of the light source. Light from the light source may be retro-reflected back towards the light source and the light-detector by means of a retro-reflective material. Said retro-reflective material maybe permanently located at a position within the beam of light, but spaced from the light source. The retro-reflective material thus normally retro-reflects light emitted by the light source back towards the light source and light-detector. If the beam of light between the light source and the retro-reflective material is selectively blocked by a user who may, for example, position his/her hand or other body part in the beam, then light no longer impinges on the light sensitive element within the detector causing a change in the output signal of the detector. Alternatively, the normal situation may be that light is not directed at the light source, and a user may carry a piece of retro-reflective material on his or her body, for example attached to a glove. In that case, if the user then selectively inserts his/her hand into the beam of light emitted by the light source, then some of the light will be retro-reflected back towards the light-detector, again causing a change in the output of the light sensitive element. By connecting the light sensitive element to a pulse generator, the analogue output of the light sensitive element can be converted to a digital signal which can be used to generate a trigger pulse when the normal situation is temporarily interrupted by blocking the beam. Alternatively the detector may be activated by selectively shining a light at the light source, e.g. by means of a hand-held lamp such as a torch.

In some instances, the trigger pulse may be connected to a MIDI interface to produce a MIDI signal. Where a plurality of light-detectors are provided, the output of each may be adapted to cause a unique MIDI-note or event, so that the light-triggering equipment may be used, for example, to play a MIDI-compatible musical instrument. The use of beams of light which are cut to control musical or other events is visually appealing and may be used to provide a fascinating performance spectacle or interactive entertainment.

As the light-detector is positioned on the axis of the beam of light from the light source, one has to be careful not to position the light-detector too close to the light source where it may be exposed to excessive heat. If the light-detector becomes too hot, then the light-sensitive element may become unreliable and ultimately fail altogether.

International patent application number PC/GB99/03177 (WO-A-00/17851) discloses a single-beam light unit in which a collimated beam of light is reflected onto a desired axis by means of a mirror that is positioned remotely from the light source. The light-detector is positioned within an aperture or recess formed in the mirror and is collimated with light from said beam which is retro-reflected back towards the mirror. In this way, the light-detector is positioned away from the light source, where it is not subjected to undue heat. However, in some instances, it may be desirable to be able to move the beam of light to enhance the visual appeal of the equipment. Thus, according to PCT/GB99/03177, means may be provided for tilting the mirror in order to change the direction of the reflected beam. In order to ensure that the light-detector remains collimated with the retro-reflected beam, corresponding tilting means are also provided for tilting the light-detector in response to movement of the mirror. Whilst technically feasible, the provision of automatically-controllable tilting means for the light-detector, particularly which enable tilting on two different axes, in response to movement of the mirror, so that the light-detector remains collimated with the beam of light at all times is technically complex and difficult to reduce to practice.

Accordingly, it is an object of the present invention to provide an improved light-detector for use with light-actuated, electronic triggering equipment.

In particular, it is an object of the present invention to provide a light-detector assembly which allows the light-detector to be positioned close to a light source without subjecting the light-detector to undue or excessive heat.

Another object of the present invention is to provide an improved light-detector assembly which allows the beam of light to be moved without moving the light-detector.

Yet another object of the present invention is to provide such an improved light-detector assembly which can be provided as an integrated unit with a light source, or can be provided as an accessory which can be retro-fitted to an existing light source.

According to one aspect of the present invention therefore there is provided a light-detector assembly for use with light-actuated, selectively operable, electronic triggering equipment of the kind described above, which assembly comprises light-detecting means; means for locating said light-detecting means off-axis in relation to a collimated source of visible light; light deflecting means; and positioning means for positioning said light-deflecting means on the optical axis of said collimated source; wherein said deflecting means are adapted to deflect towards said light-detecting means, light, such as retro-reflected light, that is directed towards the source.

Usually, said detector will be adapted to detect light from the light source that is retro-reflected back towards the source.

The present invention thus provides a light-detector assembly in which the light-detector may be positioned close to a light-source, without being positioned actually within a beam emitted by said light source. Said light-detector is thus not subject to undue or excessive heat. Furthermore, said beam may be further reflected to a desired direction by means of a mirror positioned at a point remote from the light source. Said mirror may be movable to alter the direction of the reflected beam, whilst the position and orientation of the light-detector remains fixed adjacent to the light source.

Typically, said deflecting means may comprise a mirror adapted to reflect said light to the light-detector. Advantageously, said mirror may be concave and adapted to focus said light onto the light-detector. The mirror may comprise a conventional, substantially opaque mirror, or may preferably comprise a one-way mirror. Said one-way mirror may be adapted to transmit light through the mirror in one direction (non-reflective) and may be wholly or substantially opaque to light in another, preferably opposite, direction (totally reflective). Said one-way mirror may be positioned within the beam of light emitted by the light source to allow the passage of light therethrough away from the source, and to be opaque to light that is retroreflected back towards the source. Thus the mirror positioned within the beam reflects said retroreflected light towards a light-detector, but does not substantially obscure the beam emitted by the light-source. Said one-way mirror is preferably mounted within the beam emitted by the light source on a support member that presents minimum obstruction to the beam. Thus, said one-way mirror may be mounted on a hollow support member such, for example as a support member having a thin, generally cylindrical wall that is mounted substantially co-axially with the beam.

Said light-detector may comprise an elongate tube, open at one end, which accommodates the light-sensitive element. Said tube may be positioned such that the light-sensitive element is collimated with the retro-reflected beam. Said tube may be oriented substantially parallel to the beam and may comprise a further mirror adapted to reflect light deflected by said deflecting means into the open end of the tube onto the light-sensitive element. Preferably, the open end of the tube may be directed away from the light source.

Said light-detector assembly may form part of an integrated light unit comprising a light source and means for collimating light from said light source to form a parallel beam. Said deflecting means may be mounted directly (e.g. by a suitable adhesive) on a lens adapted for collimating light from said light source.

Alternatively, said light-detector assembly may be adapted to be retro-fitted to an existing light unit comprising a light source. Accordingly, said deflecting means may be mounted on a spider which is adapted to be fixedly secured to the light unit within the beam.

According to a particularly preferred aspect of the present invention, said deflecting means may comprise a plurality of mirrors, and a corresponding plurality of light-detectors may be provided that are spaced around the beam, wherein each of said light-detectors is collimated with a respective one of the mirrors. Each mirror may be concave and adapted to focus light onto a respective detector and one or more, preferably all, of said mirrors may be one-way mirrors as described above. Each light-detector may be “tuned” to detect light of the same or a different wavelength from the other light-detectors. In some embodiments, said deflecting means may comprise a pyramid having a plurality of mirrored faces. Thus, said pyramid may comprise 3, 4, 5 or more faces. Said mirrors may be contiguous or spaced from one another across the axis of the beam, and a plurality of light detectors, each associated with a respective one of the mirrors, may be used to detect the speed (velocity) with which, and the direction from which the beam is cut Such information may be encoded as part of the output signal of the triggering equipment to control the envelope of a musical note or other event. Alternatively, the detectors can be used to drive a plurality of different triggerable devices.

One of said light-detectors may be adapted to detect non-visible light such, for example, as infra-red light. Said light-detector assembly may thus be used in conjunction with one or more light sources adapted to emit light of different wavelengths. Preferably, said light-detector assembly may be used in association with visible and infra-red light sources. Where light-actuated triggering equipment is used in a smoky environment such, for example, as in the vicinity of smoke machines, the presence of opaque smoke particles in the air may obstruct the beam giving rise to a “false” signal. The use of an infra-red beam and associated light-detector in association with a visible light beam and corresponding light-detector may be used to overcome this problem by providing a positive output trigger signal, only when a pulse is generated by both the visible light-detector and the infra-red light-detector.

In some embodiments, the light-detector assembly may be adapted for use in the “normally off” mode in which a trigger pulse signal is generated by selectively positioning a piece of retro-reflective material temporarily in the beam to retro-reflect light back on to the light-detector, or shining light from another source (e.g. a hand-held torch) towards the source. Alternatively, the assembly may be adapted to be used in a “normally on” (“inverse”) mode in which a piece of retro-reflective material is permanently positioned so as to retro-reflect light of the beam back towards the light source, and a trigger signal is produced by selectively and temporarily blocking the beam between the light source and the retro-reflective material.

Where a plurality of light-detectors are provided, each tuned to a different wavelength of light, then the assembly may be operated using a corresponding plurality of different kinds of retro-reflective material, wherein each piece of retro-reflective material is adapted exclusively to reflect light of a specific wavelength or range of wavelengths corresponding to a respective one of the light-detectors. Thus, each of the light-detectors can be “triggered” independently from the others by using a corresponding retro-reflective material. In some embodiments in the “normally on” mode, said pieces of different retroreflective material may be spatially arranged in non-overlapping relation to each other, and each mirror may be oriented to receive retroreflected light from a respective one of the pieces.

In some embodiments, the or each light-detector may incorporate a pulse generator for converting the output analogue signal of the light-sensitive element to a digital trigger signal. For some applications, the output signal of the or each pulse generator may be MIDI-compatible.

According to another aspect of the present invention, said light-detector assembly may comprise a further tiltable mirror spaced from said deflecting means on the optical axis of the beam. Said tiltable mirror may be adapted to be tilted to adjust to the direction of the beam. In some embodiments, movement of the tiltable mirror may be motorised and, optionally, computer-controlled.

Following is a description by way of example only with reference to the accompanying drawings of embodiments of the present invention.

In the drawings:

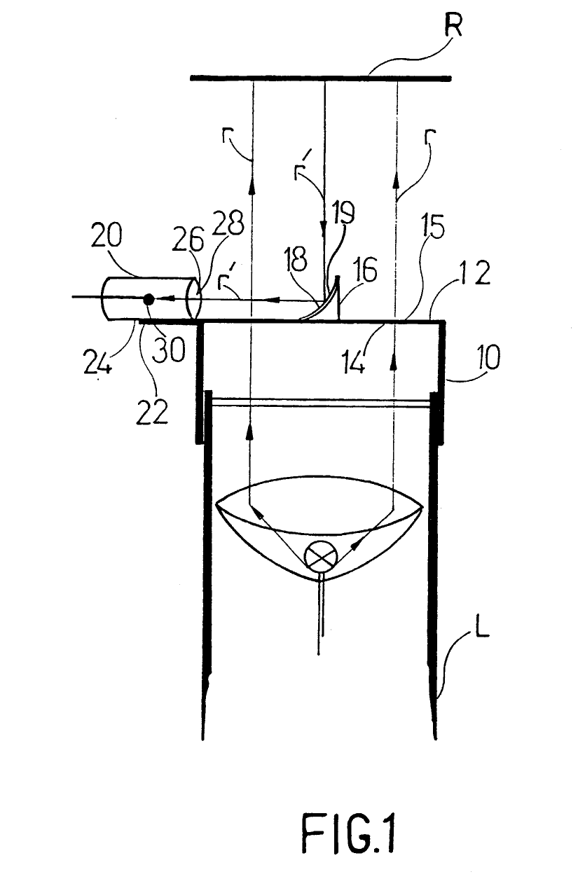

FIG. 1 is a schematic, sectional side view of a light-detector assembly in accordance with the present invention that is retro-fitted to an existing light unit; and an associated piece of retro-reflective material.

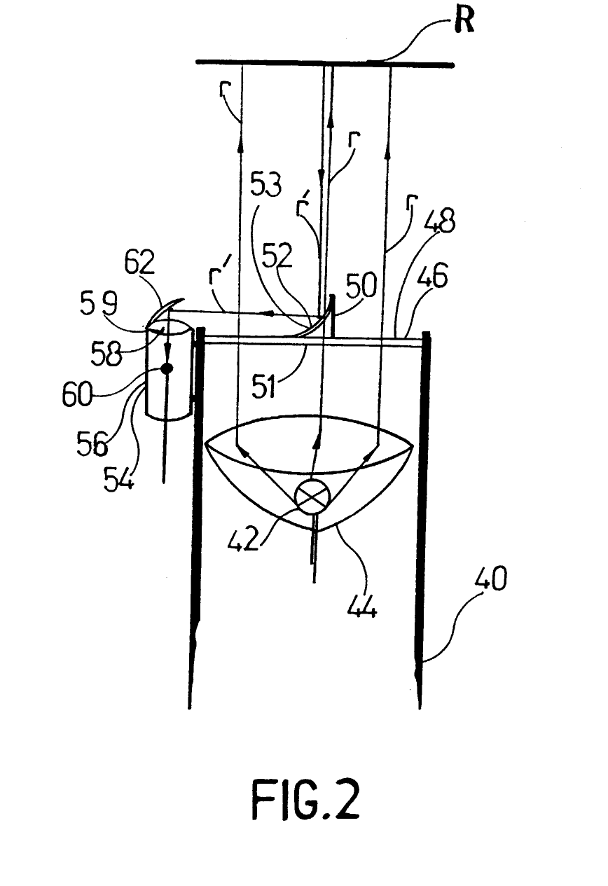

FIG. 2 is a schematic, sectional side view of another light-detector assembly in accordance with the present invention that is provided as an integral part of a light unit.

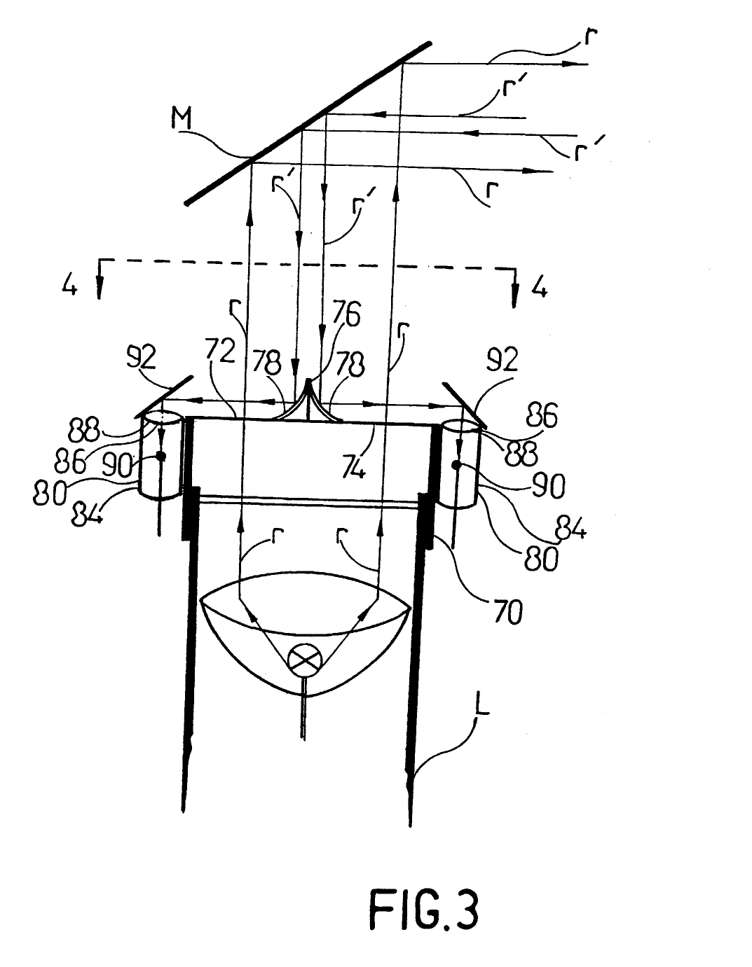

FIG. 3 is a schematic, sectional side view of another retro-fitted light-detector assembly in accordance with the present invention that comprises a plurality of light detectors that are sensitive to the same or different wavelengths of light.

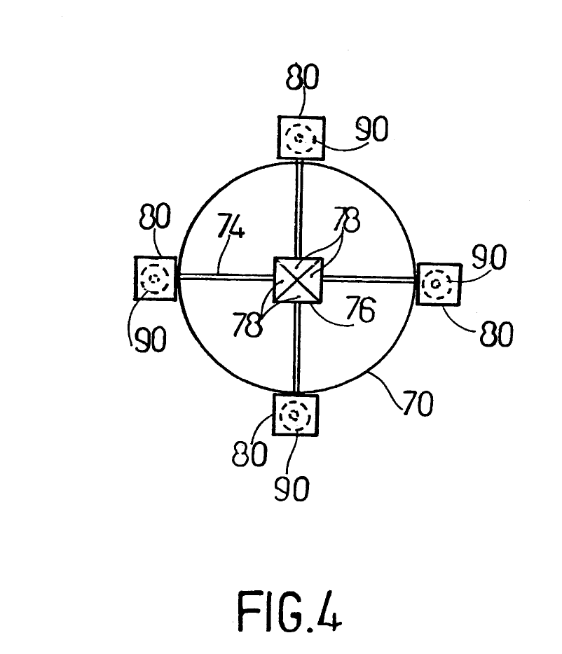

FIG. 4 is a schematic, plan view of the retro-fitted light-detector assembly of FIG. 3, as viewed on line 4-4 indicated in FIG. 3.

With reference to FIG. 1, a light-detector assembly in accordance with one embodiment of the present invention comprises an opaque, tubular housing 10 that is open at both ends. Said housing 10 is adapted to be fitted to an exiting light unit L, such that the light unit L is received within housing 10. Said light unit L is adapted to produce a collimated beam of light, indicated in FIG. 1 by rays r. Said housing 10 can be fixedly secured to the light unit L such that the optical axis of the collimated beam is aligned substantially coaxially with the longitudinal axis of the tubular housing 10, and the beam is directed out of the housing 10 through one of the open ends 12 of the housing.

Said open end 12 is fitted with a spider 14. Said spider 14 carries a prism 16 that is mounted on an outer surface 15 of the spider 14 on the axis of the beam. Said prism 16 comprises an angled, concave face 18 that is oriented at an angle of approximately 45° to the plane of the spider 14 and carries a layer of reflective material 19.

Light from the light unit L is directed away from the light unit as a collimated beam, through the spider 14, and away from the assembly. When the rays r fall incident on a piece of retro-reflective material R, some of the rays r will be retro-reflected back towards the assembly as indicated by ray r′ in FIG. 1. Said retro-reflected light r′ will fall incident upon the reflective material 19, and the shape and position of said reflective material 19 are such that said retroreflected light is reflected through an angle of about 90°, such that the retro-reflected light is directed away from the prism 16 substantially radially with respect to the collimation axis of the light unit L.

Said tubular housing 10 carries on its outer surface a light-detector 20 which is fixedly secured to an outer the surface of the housing 10 by means of a suitable bracket 22. Said light-detector 20 comprises an elongate, hollow casing 24 having an open end 26. Said open end 26 is fitted with a lens 28, and the casing 24 accommodates a light-sensitive element 30. As can be seen from FIG. 1, the light-detector 20 is fixedly secured to the housing 10 such that the light-sensitive element 30 is collimated with retro-reflected light that is reflected by the reflective material 19 carried by said prism 16, and the open end of the casing 24 is directed inwardly, such that said reflected, retro-reflected light falls incident upon the lens 28 which focuses said reflected, retro-reflected light onto the light-sensitive element 30. The concave surface 18 of the prism 16 is shaped to focus said retro-reflected light onto said light-sensitive element 30.

As described in U.S. Pat. No. 5,017,770 and PCT/GB99/03177 (WO-A-00/17851) the light-sensitive element is adapted to produce a positive electrical signal when light is incident upon it. Thus, when rays of light r are retro-reflected back towards the light unit by a piece of retro-reflective material R, some of the retro-reflected rays are r′ will fall incident on the light-sensitive element, giving rise to a positive output signal. As described in U.S. Pat. No. 5,017,770 and PCT/GB99/03177, this positive signal can be used as a trigger signal to drive a wide variety of different performance or entertainment events. In particular, the output of said light-sensitive element may be used to trigger operation of a music synthesizer.

In some embodiments, the analogue output of said light-sensitive element 30 may be connected to a pulse generator to convert the analogue output to a digital signal.

An advantage of the light-detector assembly as herein described with the reference to FIG. 1 is that the light-sensitive element 30 is positioned close to the light unit, but is disposed outside the beam of light I emitted by the light unit, so that the light-sensitive element is not subjected to undue or excessive heat.

Another embodiment of the present invention is illustrated in FIG. 2 in which an integrated light unit 40 comprises a lamp 42 that is positioned substantially at the focal point of a parabolic reflector 44, and a lens 46. Said light unit 40 is adapted to produce a beam of collimated light, indicated by rays r. Said lens 46 has an outer surface 48 which faces away from the lamp 42 and carries a support member 50 that is positioned substantially centrally of the lens 46 and is glued thereto by a suitable adhesive. Said support member 50 comprises a cut-away, hollow cylinder having an end 51 that is shaped to conform to the outer surface 48 of the lens 46 and is fixedly secured contiguously thereto, and a second curved end 52 that, on the axis of said cylinder, subtends an angle of about 45° to said axis. Said curved end 52 may suitably have a parabolic shape, and carries a correspondingly shaped, thin piece of a “one-way” mirror material 53 that is substantially wholly transparent to light emitted by the light unit 40 and is substantially wholly reflective to light directed towards said light unit. Said piece of “one-way” mirror material 53 is thus positioned so that light from the light unit 40 that is retro-reflected back towards the light unit is reflected by the outer reflective surface of the “one-way” mirror material 53 substantially radially of the light unit 40. Said light unit 40 comprises a light-detector 54 that is mounted on an outer surface of the light unit. Said light-detector 54 is similar to the light-detector 20 included in the light-detector assembly of FIG. 1, in that it comprises a casing 56 with an open end 58, a lens 59 and a light-sensitive element 60. As can be seen from FIG. 2, however, the light-detector 54 is mounted such that the longitudinal axis of the casing 56 is oriented substantially parallel to the collimation axis of the light unit 40. Thus, said light-detector 54 carries an optically concave mirror 62 or other reflecting means that is adapted to reflect further the retro-reflected light that is reflected radially by the “one-way” mirror material 53, into the open end 58 of the light-detector 54, where it is focused by the lens 59 onto the light-sensitive element 60. The light-detector 54 is thus positioned adjacent to the light unit 40, but is disposed outside the beam of light emitted by the light unit 40, so that the light-sensitive element 60 is not subjected to undue of excessive heat in use. The cylindrical support member 50 and piece of “one-way” mirror material 53 do not substantially obstruct the passage of light from the unit 40, and furthermore, by orienting the light-detector 54 substantially parallel to the beam, a more compact arrangement may be provided.

The light-detector assemblies in accordance with the present invention may be operated in “normal” or “inverse” modes as described in U.S. Pat. No. 5,017,770. Thus, in the “inverse mode” a piece of retro-reflective material R may be permanently positioned in relation to the light unit 40, so that light from the light unit is normally retro-reflected back towards the light unit and is incident upon a light-sensitive element to give a positive signal. When the beam is selectively blocked, light is prevented from returning towards the light unit and being incident on the light-sensitive element, so the output of the light-sensitive element falls. This drop in the analogue output of the light-sensitive element may be converted by a suitable pulse generator to provide a trailing edge pulse signal which can be used to trigger a suitably configured electronic devices such as MIDI-controllable equipment. In the “normal” mode, the light of the beam is not normally retro-reflected, but when a piece of retro-reflective material R is selectively introduced into the beam of light emitted by the light unit 40, the strength of the output signal of the light-sensitive element increases, and this may be converted by a pulse generator to provide a leading edge trigger signal. Said digital pulse may be inputted to, for example, a MIDI interface for driving a MIDI device.

A third embodiment of the present invention is illustrated in FIGS. 3 and 4. With reference to FIG. 3, a retro-fittable light-detector assembly comprises a tubular housing 70 that is similar to the housing 10 of FIG. 1. Said housing 70 is adapted to accommodate a pre-existing lamp unit L, which lamp unit is adapted to produce a collimated beam of light, indicated by rays r in FIG. 3. An open end 72 of the housing 70 is fitted with a spider 74 which carries a solid, opaque pyramid 76 having four triangular angled, flat or concave faces 78. Said pyramid 76 is positioned on the spider substantially centrally with respect to the optical axis of the lamp L, and each triangular face 78 subtends an angle of about 45° with the plane of the spider 74. Each angled face 78 carries a layer of reflective material. Of course, it will be appreciated that instead of the solid, opaque pyramid 76, a hollow generally cylindrical support member carrying a plurality of pieces of “one-way” mirror material could be used in the same way as in the second embodiment described above.

Each triangular face 78 of the pyramid 76 is collimated with and adapted to focus light onto a respective light-detector 80. Thus, four light-detectors are provided which are circumferentially equally-spaced around the housing 70. The light-detectors 80 are fixedly secured to the housing 70 by suitable fixings (not shown). It will be appreciated that by way of alternatives, 2, 3, 5 or more light-detectors 80 may be used, and the pyramid 76 will have a corresponding number of reflecting faces 78.

Each light-detector comprises an elongate, hollow housing casing 84 having an open end 86 which is preferably fitted with a lens 88. The casing 84 of each light-detector 80 accommodates a light-sensitive element 90. As with the integrated light unit shown in FIG. 2, the light-detectors 80 included in the retro-fittable light-detector assembly of FIGS. 3 and 4 are oriented with their longitudinal axis substantially parallel to the collimation axis of the lamp unit L, and each light-detector 80 comprises a mirror 92 that is collimated with a respective angled face 78 of said pyramid 76 for reflecting light from said face into the open end 86 of the respective light-detector 80 where it is focused by said lens 88 onto the light sensitive element 90.

Said light-detector assembly further comprises a motorised, tiltable mirror M which is located at a position remote from said lamp unit L and is collimated with said lamp unit. As shown in FIG. 3, the tiltable mirror M is adapted to redirect the beam of light emitted by the lamp unit L, and by tilting the mirror M, the beam can be selectively moved to enhance the functionality of the equipment and, particularly, to provide a visually more appealing and exciting effect. Light produced by said lamp unit L may be retro-reflected back towards the lamp unit by interposing a piece of retro-reflective material (not shown) in the beam. Said retro-reflective material may be permanently placed in the beam to operate in the “inverse” mode or the “normal” mode, as described above. When rays r of the beam fall incident on the retro-reflective material, they are retro-reflected back as return rays r′ towards the mirror M, where they are reflected back towards the lamp unit L. The retro-reflected rays r′ then fall incident on the angled faces 78 of the pyramid 76 and may be detected by the light-sensitive element in at least one of the light-detectors 80.

Advantageously, the light unit L is adapted to produce a beam comprising light of a plurality of different wavelengths, and the light-sensitive 90 of each light-detector may be adapted to detect a different respective one of said wavelengths. In particular, the lamp unit L may be adapted to produce a beam of light comprising visible light and infra-red light. One or more of the light-detectors 80 may be adapted to respond to infra-red light, whilst one or more of said light-detectors 80 may be adapted to respond to visible light.

When the light-actuated triggering equipment is operated in the inverse mode in, for example, a smoky environment, particles of smoke in the air may block the visible light. However, smoke will not block the infra-red light. The output signals of the light-detectors 80 may be electronically compared, such that a trigger signal is only generated when all of the light-sensitive elements (visible and infra-red sensitive) give a positive output signal. Thus, “true” triggering actions by blocking the beam may be distinguished from “false” blocks where only the visible light is be obstructed by smoke particles.

Alternatively, the equipment may be operated in the “normal” mode using retro-reflective materials that are adapted to retro-reflect light of different wavelengths. The light-sensitive elements 90 within the light-detectors 80 may be adapted to respond to different respective wavelengths, so that the light-detector assembly illustrated in FIGS. 3 and 4 is capable of producing a plurality of different trigger signals according to which wavelength of light is retro-reflected back towards the assembly. In an “inverse” (normally on) mode, pieces of different wavelength retroreflective materials may be fixed remotely in relation to the detector assembly and arranged spatially in non-overlapping relation to each other. Each face 78 of the pyramid 76 may be carefully oriented to receive light substantially exclusively from a respective one of the retroreflective pieces, whereby different combinations of devices can be triggered according to the wavelength(s) of light emitted by the source and retroreflected back onto the detector assembly, for example where a light unit of selectively variable or interchangeable wavelength is used.

The assembly shown in FIGS. 3 and 4 has the advantage that the light-detectors 80 are positioned adjacent to the lamp-unit, but are disposed outside the beam of light produced by the lamp-unit, so that the light-sensitive elements 90 are not subjected to excessive or undue heat in use. Furthermore, the assembly of FIGS. 3 and 4 has the additional advantage that the beam of light produced by the light unit L can be moved using the tiltable mirror M to enhance the visual appeal of the spectacle produced by the equipment in use. The use of the tiltable mirror M in accordance with the invention does not require the use of a movable light-detector.

1. A light-detector assembly for use with light-actuated, selectively operable, electronic triggering equipment, which assembly comprises light-detecting means (20; 54; 80); means for locating said light-detecting means off-axis in relation to a collimated source of visible light (L; 40); light deflecting means (19; 53; 78); and positioning means (14; 48; 74) for positioning said light deflecting means on the optical axis of said collimating source; wherein said deflecting means are adapted to deflect towards said light-detecting means, light, such as retro-reflected light, that is directed towards the source.

2. A light-detector assembly as claimed in claim 1, wherein the detector (20; 54; 80) is adapted to detect light from the light source that is retroreflected back towards the source.

3. A light-detector assembly as claimed in claim 1 or claim 2, further comprising a mirror (M) that may be positioned at said point remote from said light source (L) in order to reflect further in a desired direction a beam emitted by said source (L).

4. A light-detector assembly as claimed in claim 3 wherein said mirror (M) is moveable to alter the direction of the further reflected beam.

5. The light-detector assembly as claimed in any preceding claim wherein said deflecting means comprise a mirror (19; 53; 76) adapted to reflect said light to the light-detector.

6. A light-detector as claimed in claim 5, wherein said mirror (19; 53; 76) is concave and adapted to focus the light onto the light-detector.

7. A light-detector assembly as claimed in claim 5 or claim 6, wherein said mirror comprises a conventional, substantially opaque mirror (19; 76) or a one-way mirror (53).

8. A light-detector assembly as claimed in claim 7, wherein the one-way mirror (53) is adapted to transmit light through the mirror in one direction and is wholly or substantially opaque to light in another direction.

9. A light-detector assembly as claimed in claim 8, wherein said one-way mirror (53) is positioned within a beam of light emitted by the light source (40) to allow the passage of light therethrough away from the source and to be opaque to light that is retro-reflected towards the source.

10. A light-detector assembly as claimed in claim 7, claim 8 or claim 9, wherein said one-way mirror (53) is mounted in the beam emitted by the light source (40) on a hollow support member (50).

11. A light-detector assembly as claimed in any preceding claim wherein said light-detector (20; 54; 80) comprises an elongate tube (24; 56; 84), open at one end (26; 58; 86), which accommodates a light-sensitive element (30; 60; 90).

12. A light-detector assembly as claimed in claim 11, wherein said tube (24; 56; 84) is positioned such that the light-sensitive element (30; 60; 90) is collimated with a retro-reflected beam.

13. A light-detector assembly as claimed in claim 11 or claim 12, wherein said tube (56; 84) is oriented substantially parallel to the beam and comprises a further mirror (62; 92) adapted to further reflect light deflected by the deflecting means (52; 78) in to the open end of the tube (58; 86) on to the light-sensitive element (60; 90).

14. A light-detector assembly as claimed in claim 11, claim 12 or claim 13, wherein the open end (58; 86) of the tube (56; 84) is directed away from the light source (40; L).

15. A light-detector assembly as claimed in any preceding claim which forms part of an integrated light unit (40) comprising a light source (42) and means (44, 46) for collimating light from said light source to form a parallel beam.

16. A light detector assembly as claimed in claim 15, wherein said deflecting means (50) are mounted on a lens (46) adapted for collimating light from the light source.

17. A light detector assembly as claimed in any of claims 1 to 14, wherein said light-detector assembly is adapted to be retrofitted to an existing light unit (L) comprising a light source.

18. A light-detector assembly as claimed in claim 17, wherein the deflecting means (18; 76) are mounted on a spider (14; 74) which is adapted to be fixedly secured to the light unit (L) within the beam.

19. A light-detector assembly as claimed in any preceding claim wherein said deflecting means (76) comprise a plurality of mirrors (78), and a corresponding plurality of light-detectors (80) are provided that are spaced around the beam, wherein each of said light-detectors is collimated with the respective one of the mirrors.

20. A light-detector assembly as claimed in claim 19, wherein each light-detector (80) is “tuned” to detect light of the same or different wavelength from the other light detectors.

21. A light-detector assembly as claimed in claim 19 or claim 20 wherein said deflecting means comprise a pyramid (76) having a plurality of mirrored faces (78).

22. A light-detector assembly as claimed in claim 21, wherein said pyramid comprises 3, 4, 5 or more faces (78).

23. A light-detector assembly as claimed in any of claims 19 to 22 wherein said mirrors (78) are contiguous or spaced from one another across the axis of the beam and a plurality of light detectors (80), each associated with the respective one of the mirrors, are used to detect the speed with which and/or the direction from which the beam is cut.

24. A light-detector assembly as claimed in any of claims 19 to 22, wherein said detectors (80) are used to drive a plurality of different, triggerable devices.

25. A light-detector assembly as claimed in any of claims 19 to 24, wherein one of said light-detectors (80) is adapted to detect non-visible light (eg infra-red light), and another of said light detectors is adapted to detect visible light, and comparing means are provided for generating an output trigger signal only when a qualitative change in the intensity of light is detected by both said non-visible light detector and said visible light detector.

26. A light-detector assembly as claimed in any of claims 19 to 24, further comprising a plurality of pieces of different kinds of retro-reflective material, wherein each kind of retro-reflective material is adapted to retroreflect exclusively light of a specific wavelength or a range of wavelengths corresponding to a respective one of the light-detectors (80); said pieces being fixed remotely in relation to the light-detector assembly and spatially arranged in non-overlapping relation to each other; and each mirror (78) being oriented to receive retro-reflected light from a respective one of said pieces.

27. A light-detector assembly as claimed in any preceding claim wherein the or each light-detector (20; 54; 80) incorporates a pulse generator for converting the output analogue signal of the light-sensitive element (30; 60; 90) to a digital trigger signal.

28. A light-detector assembly as claimed in any preceding claim further comprising a tiltable mirror (M) spaced from the deflecting means (76) on the optical axis of the beam; which tiltable mirror is adapted to be tilted to adjust the direction of the beam.

29. A light-detector assembly as claimed in claim 28, wherein movement of the tiltable mirror is motorised and optionally computer-controlled.
